(19) United States
(12) Patent Application Publication
(10) Pub. No.: US 2010/0023676 A1
(43) Pub. Date: Jan. 28, 2010

(54) SOLID STATE STORAGE SYSTEM FOR DATA MERGING AND METHOD OF CONTROLLING THE SAME ACCORDING TO BOTH IN-PLACE METHOD AND OUT-OF-PLACE METHOD

(76) Inventors: Yang-Gi MOON, Ichon-shi (KR); Dae-Hee YI, Seoul (KR)

Correspondence Address: LADAS & PARRY LLP, 224 SOUTH MICHIGAN AVENUE, SUITE 1600, CHICAGO, IL, 60604, US

(21) Appl. No.: 12/344,756

(22) Filed: Dec. 29, 2008

(30) Foreign Application Priority Data
Jul. 25, 2008 (KR) 10-2008-0073019

(51) Int. Cl. G06F 12/02; G06F 12/00

(52) U.S. Cl. 711/103; 711/173; 711/170; 711/E12.001; 711/E12.002; 711/E12.008

(57) ABSTRACT

A solid state storage system includes a controller configured to divide memory blocks of a flash memory area into first blocks and second blocks corresponding to the first blocks, newly allocates pages of the second blocks when an external write command is requested. The controller is also configured to allocate selected sectors in the allocated pages according to sector addresses and execute a write command.

### CROSS-REFERENCES TO RELATED APPLICATION

The present application claims priority under 35 U.S.C. § 119(a) to Korean Patent application number 10-2008-0073019, filed on Jul. 25, 2008, in the Korean Intellectual Property Office, which is incorporated herein by reference in its entirety as if set forth in full.

### BACKGROUND OF THE INVENTION

The present invention relates generally to a solid stage storage system and a method of controlling the same, and more particularly to a solid state storage system for data merging and a method of controlling the same.

In general, non-volatile memories (i.e., memories that retain data stored therein even when power is not supplied to the memory) have been used as memories for portable information devices. Recently, a solid state drive (SSD) using a NAND flash memory has begun to be used in a personal computer (PC) instead of a hard disk drive (HDD). Therefore, it is anticipated that the SSD will make inroads into the share market of the HDD.

Examples of an address mapping method of a memory area of a solid state storage system, such as the SSD, include a block unit mapping method, a page unit mapping method, and a hybrid mapping method using both the block unit mapping method and the page unit mapping method. In the block unit mapping method, a physical block address and a logical block address are mapped. In the page mapping method, (called a sector mapping method) a mapping table is made in a page unit and a physical page address and a logical sector address are mapped. When page mapping is performed, a substantial page address of a NAND flash memory can be recognized by searching the mapping table, and the NAND flash memory can be operated at a high speed. However, the mapping storage capacity inevitably increases in the NAND flash memory. In the block mapping method tables are stored in the NAND flash memory to correspond to the number of blocks of the NAND flash memory, and as such, it is possible to reduce the mapping storage capacity as compared with the page mapping method. However, the block mapping method is ineffective during an overwrite process. In the hybrid mapping method, a mapping storage capacity is reduced using the block mapping method as a basic mapping method, and the page mapping method is used for a log block. In this case, as mapping methods that can use a log block, the page mapping method and the hybrid mapping method are mainly used. For convenience of explanation, the description is made on the basis of the hybrid mapping method.

In the log block mapping method, a memory block of a memory area is divided into a data block and a log block, and a log block through mapping is allocated more preferentially than the data block that is designated according to a logical address and data is stored. The data block is processed by using an in-place method and the log block is processed by using an out-of-place method, in which data is stored in the order of data input from the host. As such, a log block is used in consideration of a place strategy according to data attributes.

In actuality, a plurality of sectors can exist in one page in the NAND flash memory. In recent years, products having NAND flash memories with a data recording capacity of (4 Kbyte+Spare) per page or more and exceeding a data recording capacity of (2 Kbyte+Spare) per page have been developed. However, in a host system, such as a PC, a basic unit of a sector is 512 Bytes, and thus one page can have a plurality of sectors.

Subsequently, a write operation is generally performed in the order of pages in a log block. When data is stored in a sector unit in one page, a method where sectors are stored in the predetermined offset is called a sector in-place method, and a method where sectors are stored at arbitrary locations in a page is called a sector out-of-place method.

For example, a log block based on an in-place method can be used for continuous data, and a log block based on an out-of-place method can be used for random data.

However, when data is continuously input to the log block based on the out-of-place method, a control operation on the data merging process is complicated and difficult.

### SUMMARY OF THE INVENTION

According to an embodiment of the present invention a solid state storage system can merge data by combining both a sector out-of-place method and a sector in-place method.

According to another embodiment of the present invention a method of controlling a solid state storage system can merge data by combining a sector out-of-place method and a sector in-place method is provided.

According to an embodiment of the present invention, a solid state storage system includes a micro controller unit (MCU) that divides memory blocks of a flash memory area into data blocks and log blocks corresponding to the data blocks, newly allocates pages of the log blocks whenever an external write command is requested, allocates selected sectors in the allocated pages according to the predetermined sector locations, and executes a write command.

According to another embodiment of the present invention, a solid state storage system includes host interface; a memory area that includes memory blocks divided into data blocks and log blocks corresponding to the data blocks; and a micro controller unit (MCU) that allocates pages of the log blocks using an out-of-place method in accordance with the order of commands generated from the host interface, allocates selected sectors in the allocated pages using an in-place method, and executes a write command.

According to another embodiment of the present invention, a solid state storage system includes a host interface; a memory area that includes memory blocks divided into data blocks and log blocks corresponding to the data blocks; and a micro controller unit (MCU) that controls address mapping between the data blocks and the log blocks in accordance with a write command from the host interface, prevents sector data storage locations from overlapping with respect to overlapping sectors in accordance with a command from the host interface, and performs a control operation such that the grouped sectors in the memory area requested in accordance with a command from the host interface are allocated to the same page in the log block.

According to another embodiment of the present invention, there is provided a method of controlling a solid state storage system that includes a micro controller unit (MCU) that divides memory blocks of a flash memory area into data blocks and log blocks corresponding to the data block and controls the individual blocks. The method includes allowing the MCU to allocate pages using an out-of-place method in a log block in accordance with an external write request and allocate selected sectors according to the predetermined sector locations of grouped sectors in the pages, using an in-place method; allowing the MCU to copy effective sectors in the data blocks and the log blocks when a data merging process needs to be performed; allowing the MCU to determine whether to execute a copy back command with respect to the effective sectors in the log blocks; and allowing the MCU to perform copy back, when the execution of the copy back command is enabled, and read the selected sectors and write data of the selected sectors in a new block, when the execution of the copy back command is disabled.

According to another embodiment of the present invention, when a data merging process is performed, a control operation can be performed such that the data merging process can be simply performed. That is, new pages are allocated in accordance with the order of commands generated, thereby preventing sectors from overlapping with respect to overlapping commands. When the sectors in the pages are allocated in consideration of a copy back command that allows a page buffer of a NAND flash memory to be used, the sectors are allocated in accordance with the predetermined locations of the sectors that are grouped in the pages. Therefore, it is possible to use the copy back command with respect to the continuous sectors. Accordingly, when the data merging process is performed, a control operation can be performed at a high speed, which results in improving performance of a solid state storage system.

### BRIEF DESCRIPTION OF THE DRAWINGS

Features, aspects, and embodiments of the present invention are described in conjunction with the attached drawings, in which:

FIG. 1 is a block diagram of a solid state storage system according to an embodiment of the present invention;

FIG. 2 is a conceptual diagram of a data merging process according to a first experimental example of in FIG. 1;

FIG. 3 is a conceptual diagram of a data merging process according to a second experimental example in the related art;

FIG. 4 is a diagram shown for illustrating commands that are executed when a data merging process of FIG. 2 is performed;

FIG. 5 is a diagram shown for illustrating commands that are executed when a data merging process of FIG. 3 is performed; and

FIG. 6 is a flowchart shown for illustrating a method of controlling a solid state storage system according to one embodiment.

### DESCRIPTION OF EXEMPLARY EMBODIMENTS

Hereinafter, a solid state storage system according to an embodiment of the present invention will be described in detail with reference to the accompanying drawings.

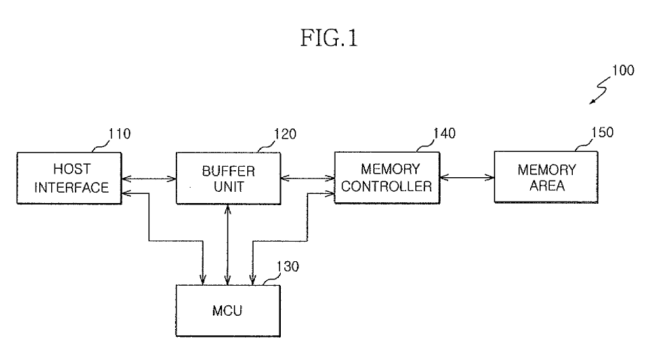

FIG. 1 is a block diagram of a solid state storage system 100 according to an embodiment of the present invention.

Referring to FIG. 1, the solid state storage system 100 includes a host interface 110, a buffer unit 120, a micro control unit (MCU) 130, a memory controller 140, and a memory area 150.

According to an embodiment of the present invention, the host interface 110 is connected to the buffer unit 120 and exchanges control commands, address signals, and data signals to/from an external host (not shown). An interface method between the host interface 110 and the external host (not shown) can be any one of a serial advanced technology attachment (SATA) method, a parallel advanced technology attachment (PATA) method, an SCSI method, a method using an express card, and a PCI-Express method. Additionally, it is to be understood that the interface methods described above are merely exemplary and the invention is not limited thereto.

The buffer unit 120 buffers output signals from the host interface 110 or data from the memory area 150. Further, the buffer unit 120 buffers output signals from the MCU 130, so as to provide the buffered signals to the host interface 110 and the memory controller 140. The buffer unit 120 can be called a common memory for buffering and is exemplified as a buffer using a static random access memory (SRAM).

The MCU 130 exchanges control commands, address signals, and data signals to/from the host interface 110 and controls the memory controller 140 using the above signals. According to an embodiment of the present invention, the MCU 130 controls address mapping on the basis of a hybrid mapping method that uses both an in-place method and an out-of-place method when controlling address mapping of the memory area 150, which will be described in detail below.

The memory controller 140 selects a predetermined NAND flash memory element (not shown) from a plurality of NAND flash memory elements in the memory area 150, and provides write, delete, and read commands.

The memory controller 140 controls the memory area 150, and write, delete, and read operations of data are performed on the memory area 150.

Memory blocks (not shown) of the memory area 150 may be set to include data blocks and log blocks. The log blocks are buffers for writing and storing data, which is to be stored in the data blocks, in a corresponding log block, in accordance with a write command.

As described above, examples of methods of allocating log blocks include the in-place method and the out-of-place method. A log block based on the in-place method is also called a sequential log block and is used for a switching operation. Specifically, with respect to a sector where a write command is to be executed, a log block based on the in-place method is controlled to be allocated to a predetermined location (in place). The log block based on the in-place method is mainly used for pure data, such as music files or movie files, which are continuously input. If all of the log blocks based on the in-place method are allocated, sectors that are selected in place are sequentially located, and thus the existing block can be switched into a new block.

A log block based on an out-of-place method, also called a random log block, performs a data merging operation. The log block based on the out-of-place method is controlled such that sectors are allocated in the order of executed orders. The log block based on the out-of-place method is mainly used for overlapping data or randomly generated control code data. If all of the log blocks based on the out-of-place method are allocated, sectors are randomly located in the log blocks. Thus, it is required to copy the data blocks and the log blocks and merge the blocks into a new block.

Due to characteristics of NAND flash memory, a copy back command can be executed with respect to a group that is configured in accordance with a predetermined rule, that is, data of sectors that are grouped in a page unit. The copy back command describes a function of using page buffers in a NAND flash memory as a memory area, buffering data of a page to be updated to an external buffer unit, and storing data in a new page of the NAND flash memory. That is, if the storage location of data is changed in accordance with the copy back command, the operation control can be simplified accordingly. Therefore, it follows that when sectors of different pages are mixed in the allocated page in the log block, the copy back command cannot be executed.

That is, execute the copy back command with respect to continuous sectors using the log block based on the out-of-place method according to the related art is difficult, and thus a complicated data merging process needs to be performed.

According to an embodiment of the present invention, the MCU 130 allocates a page of the log block in accordance with a command input from the host interface 130, and selected sectors in the allocated page of the log block are allocated on the basis of sectors grouped in the same page of the memory area 150, that is, in accordance with the predetermined sector permutation. According to an embodiment of the present invention, the MCU 130 performs a control operation such that performing the data merging process with respect to the continuous data is made easy.

That is, pages are allocated in accordance with the order of commands that are generated from the host interface 110 using the out-of-place method, and sectors that are selected according to the in-place method are located in the allocated pages, so as to allow the data merging process to be easily performed on the continuous data.

The above contents will be described in detail with reference to the following experimental examples.

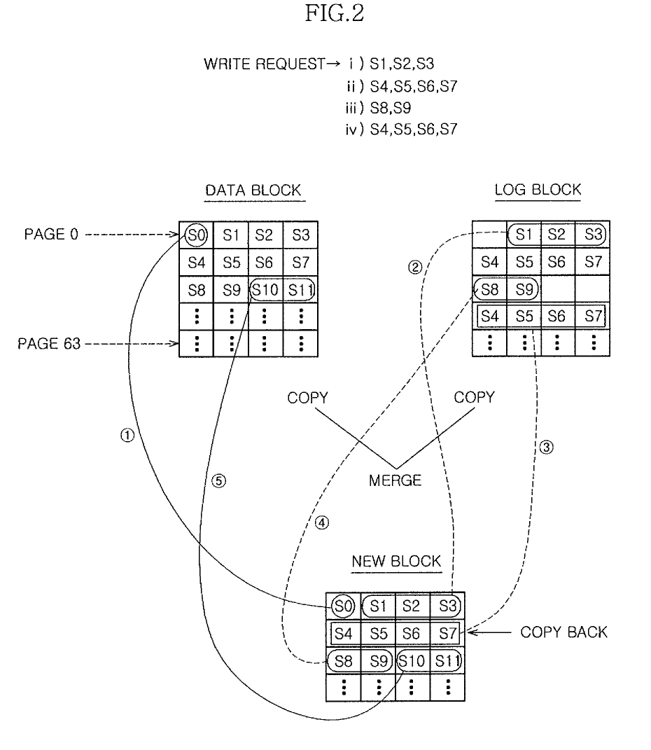

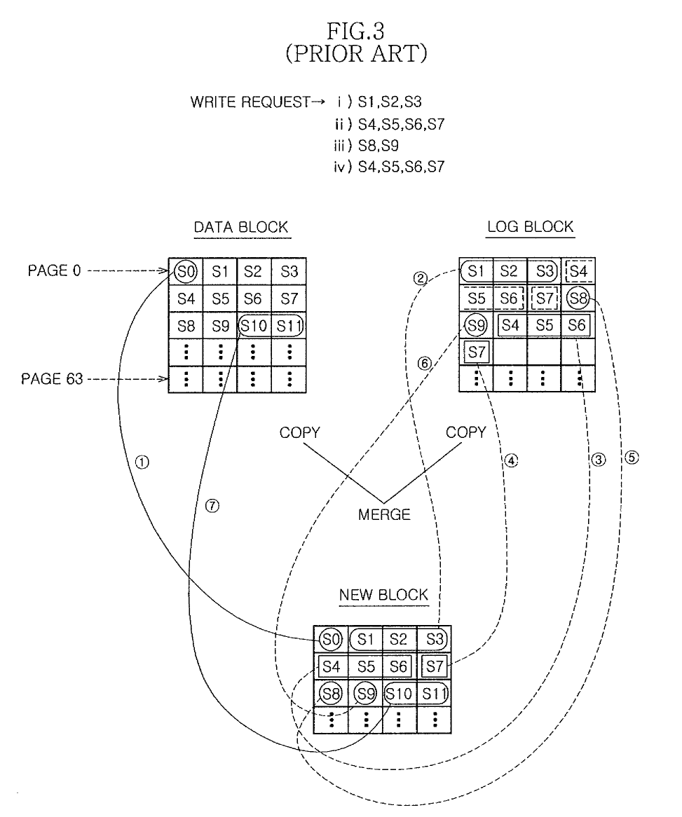

FIGS. 2 and 3 are conceptual diagrams of a data merging process.

An embodiment of the present invention will be described with reference to the following specific experimental examples. Since the contents that are not described therein can be easily recognized and understood by those skilled in the art, the detailed description thereof will be omitted.

FIG. 2 is shown to illustrate a case where a data merging process is performed using both an out-of-place method and an in-place method according to an embodiment of the present invention.

### FIRST EXPERIMENTAL EXAMPLE

First, to aid in description it is assumed that the data block and the log block each includes 64 pages, and each of the pages includes four sectors. The sectors in the pages of the data block indicate sectors that can use page buffers of a memory block (not shown) in the memory area 150, as shown in FIG. 1, and are grouped in accordance with the predetermined rule.

The host interface 110, as shown in FIG. 1, requests to write data in the first to third sectors using the first command, the fourth to seventh sectors using the second command, the eighth and ninth sectors using the third command, and the fourth to seventh sectors using the fourth command. The commands (write requests) are denoted by i-iv in FIG. 2.

When the host interface requests to continuously write data, the log block allocation of the MCU 130, as shown in FIG. 1, according to an embodiment of the present invention is as follows.

In accordance with the first command, the first page of the log block is allocated, and the first to third sectors S1 to S3 in the allocated first page are allocated using the in-place method and data is written therein.

In accordance with the second command, the second page of the log block is allocated, and the fourth to seventh sectors S4 to S7 in the allocated second page are allocated using the in-place method and data is written therein.

In accordance with the third command, the third page of the log block is allocated, and the eighth and ninth sectors S8 and S9 in the allocated second page are allocated using the in-place method and data is written therein.

In accordance with the fourth command, the fourth page of the log block is allocated, and the fourth to seventh sectors S4 to S7 in the allocated second page are allocated using the in-place method and data is written therein.

Here, the in-place method describes a permutation of sequentially grouped sectors in the corresponding page such that the above-described page buffer can be used. Accordingly, according to an embodiment of the present invention, when the sectors are allocated, if the selected sector is not in place, the selected sector is allowed to generate a vacant sector or area.

Subsequently, if all of the log blocks are allocated or a current point of time becomes a data merging point of time in accordance with a predetermined command, the contents of the data block and the log block are merged into a new data block.

Through the data merging process that is performed by the MCU 130, data of the data block and data of the log block are copied. First, it is determined which of the data block and the log block has effective sectors. That is, the sectors that are allocated in the log block are sectors on which data updating is completed, and become effective sectors. However, the sectors that are not allocated in the log block, corresponding sectors in the data block can become effective sectors.

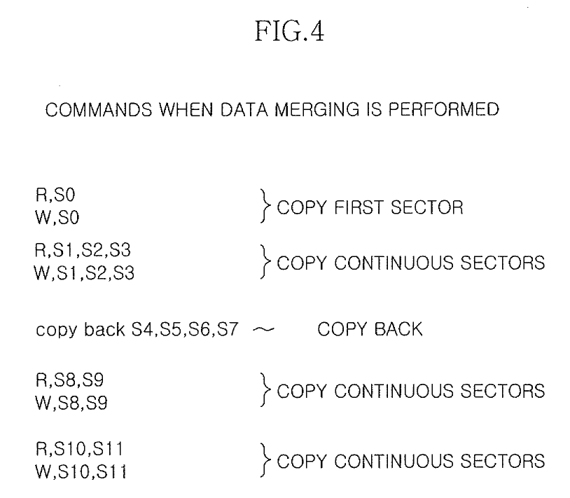

The zero-th sector S0 is an effective sector that exists in only the data block, and thus copied from the data block to a new block (refer to \textcircled{1} in FIG. 3). The first to third sectors S1 to S3 exist in the log block, and thus the first to third sectors S1 to S3 are copied from the log block to a new block (refer to \textcircled{2} in FIG. 3). The fourth to seventh sectors in the log block are overlapping sectors, and thus the newest sectors, that is, the sectors of the last page are referred to (refer to \textcircled{3} in FIG. 3). At this time, due to characteristics of the flash memory, a copy back command can be executed with respect to the sector group of the same page. Accordingly, the fourth to the seventh sectors S4 to S7 belong to a sector group that has been grouped, that is, a sector group that can use the same page buffer, and thus copied back (refer to \textcircled{3} in FIG. 3). The eighth and ninth sectors S8 and S9 exist in the log block, and thus are copied from the log block to a new block (refer to \textcircled{4} in FIG. 4). The tenth and eleventh sectors S10 and S11 exist in only the data block, and thus are copied from the data block to a new block (refer to \textcircled{5} in FIG. 4).

FIG. 3 shows the case where a data merging process is performed using an out-of-place method according to the related art.

### SECOND EXPERIMENTAL EXAMPLE

First, an experiment was performed under the same condition as the first experimental example. That is, it is assumed that each of the data block and the log block includes 64 pages, and each of the pages includes four sectors. The sectors in the pages of the data block indicate sectors that can use page buffers of a memory block (not shown) in the memory area 150 of FIG. 1 and are grouped in accordance with the predetermined rule.

The host 110 of FIG. 1 requests to write data in the first to third sectors using the first command, the fourth to seventh sectors using the second command, the eighth and ninth sectors using the third command, and the fourth to seventh sectors using the fourth command. The commands (write requests) are denoted by i-iv in FIG. 3.

As such, when the host interface requests to continuously write data, the log block allocation of the MCU 130 of FIG. 1 according to the related art is as follows.

In accordance with the first command, the first to third sectors S1 to S3 in the first page of the log block are sequentially allocated and data is written therein.

In accordance with the second command, the fourth to seventh sectors S1 to S7 are sequentially allocated after the previously allocated sectors and data is written therein.

In accordance with the third command, the eighth and ninth sectors S8 and S9 are allocated after the previously allocated sectors and data is written therein.

In accordance with the fourth command, the fourth to seventh sectors S4 to S7 are sequentially allocated after the previously allocated sectors and data is written therein.

Then, if all of the log blocks are allocated or a current point of time becomes a data merging point of time in accordance with a predetermined command, contents of the data block and the log block are merged into a new data block.

At this time, focusing on the second experimental example, that is, the data merging process according to the related art, data of the data block and data of the log block are copied. First, the zero-th sector S0 is an effective sector that exists in only the data block, and the zero-th sector S0 is thus copied from the data block to a new block (refer to \textcircled{1} in FIG. 3). The first to third sectors S1 to S3 exist in the log block, and thus copied from the log block to a new block (refer to \textcircled{2} in FIG. 3). The fourth to seventh sectors S4 to S7 in the log block are overlapping sectors, and thus the newest sectors, that is, the sectors of the last page, are referred to. At this time, since the seventh sector S7 is allocated to another page in the sector group, the fourth to sixth sectors S4 to S6 are copied (refer to \textcircled{3} in FIG. 3). The seventh sector S7 of another page is copied (refer to \textcircled{4} in FIG. 3). The eighth and ninth sectors S8 and S9 exist in the log block, and thus the eighth and ninth sectors S8 and S9 need to be copied from the log block to a new block. In this case, since the eighth and ninth sectors S8 and S9 are allocated to different pages, such that the eight and ninth sectors cannot be continuously copied. Therefore, the eighth and ninth sectors are individually copied (refer to \textcircled{5} and \textcircled{6} in FIG. 3). The tenth and eleventh sectors S10 and S11 exist in only the data block, and thus the tenth and eleventh sectors S10 and S11 copied from the data block to a new block (refer to \textcircled{7} in FIG. 3).

As described above, according to an embodiment of the present invention, control of the sector allocation is simplified by using both the in-place method and the out-of-place method. That is, the sectors are allocated in accordance with the order (locations) of grouped sectors in the page and thus a simple copy back command can be used.

In order to specifically describe the above-described experimental examples, hereinbelow description is given of commands that are executed when a data merging process according to each of the experimental examples is performed.

First, FIG. 4 shows commands that are executed when a data merging process is performed using both the out-of-place method and the in-place method according to the first experimental example.

Referring to FIG. 2 again, copying the zero-th sector S0 to a new block is to substantially read data of the zero-th sector S0 and write the data in a new block. In the continuous sector copying, when the first to third sectors S1 to S3 of FIG. 2 are copied (refer to \textcircled{2} in FIG. 2), a read operation can be continuously performed from the read start sector to the read completion sector in accordance with one read command, and a write operation can be continuously performed with respect to the continuous sectors in accordance with one write command. The fourth to seventh sectors S4 to S7 are equal to a combination of sectors that are grouped in the same page of the memory area 150 of FIG. 1. In an embodiment of the present invention, the sectors can be simply copied using the copy back command (refer to \textcircled{3} in FIG. 2). Hereinafter, copying (refer to \textcircled{4} in FIG. 2) of the eighth and ninth sectors S8 and S9 and copying (refer to \textcircled{5} in FIG. 2) of the tenth and eleventh sectors S10 and S11 can be performed in accordance with a continuous read command and a continuous write command.

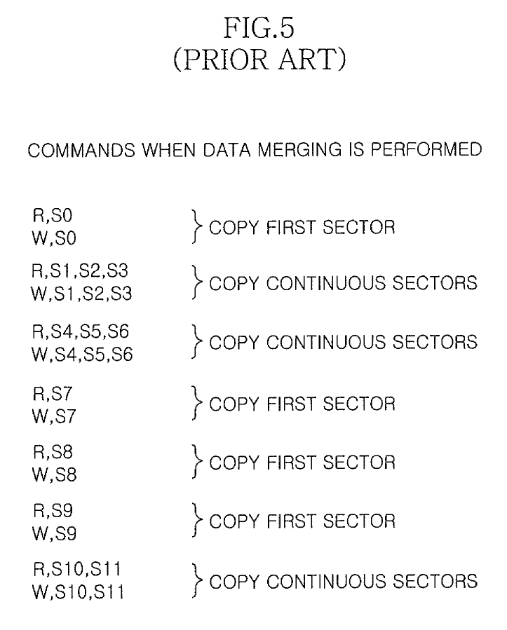

Meanwhile, FIG. 5 shows commands that are executed when a data merging process is performed using the out-of-place method according to the second experimental example.

Since the sector copying process according to the second experimental example is the same as sector copying process according to the first experimental example, the repetitive description will be omitted. As shown in FIG. 5, the copy back command is not used in the second experimental example. Referring to FIG. 3 again, in the order of commands generated from the host interface 110 of FIG. 1, the sectors are sequentially allocated. Thus, when a write command is generated and all of the continuous sectors cannot be allocated to the same page a portion of the continuous sectors is allocated to another page. Therefore, it is difficult to execute the copy back command in the log block that is controlled by using only the out-of-place method.

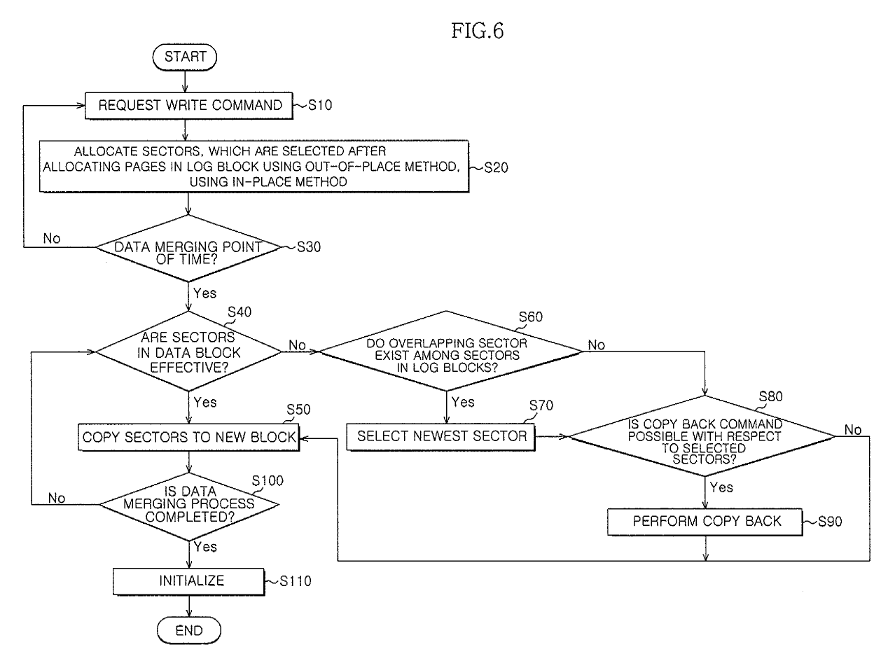

FIG. 6 is a flowchart shown for illustrating a method of controlling a solid state storage system according to an embodiment of the present invention.

First, a write command is provided from the host interface 110 of FIG. 1 (step S10).

In accordance with the corresponding command, the MCU 130 of FIG. 1 allocates pages in the log block using the out-of-place method, and allocates sectors selected according to the predetermined locations of sectors grouped in the pages, using the in-place method (step S20).

In step S30 it is determined whether a current point of time is a data merging point of time, and the previous steps performed with respect to the log blocks are repeated until the current point of time becomes a data merging point of time and the sectors are allocated. Subsequently, when all of the log blocks are allocated or the data merging process needs to be performed in accordance with the predetermined command, the data merging process is performed.

In this case, the MCU 130 of FIG. 1 determines whether the sectors in the data block to be merged are effective (step S40). That is, if non-updated sectors remain in the log block, the selected sectors in the data block are copied to a new block (step S50). As described above, the copying is to read data from the existing data block or the selected sectors from the existing log block in accordance with a read command and write the data in a new block.

However, if the sectors in the data block are not effective the sectors having data stored therein remain in the log block. Thus, a preparation process to copy the sectors in the log block is performed.

Accordingly, the MCU 130 of FIG. 1 determines whether overlapping sectors exist from the sectors in the log block (step S60). If the overlapping sectors exist, the MCU 130 selects the newest updated sector (step S70), and determines whether a copy back command can be executed with respect to the selected sector (step S80). If the overlapping sectors do not exist, the MCU 130 determines whether the copy back command can be executed with respect to the existing sectors (step S80).

In the case where the copy back command can be executed, the MCU 130 of FIG. 1 executes the copy back command (step S90) and copies the sector to a new block (step S50). In the case where the copy back command cannot be executed, the MCU 130 performs a control operation such that the sector is copied to a new block through the normal copying operation (step S50).

After performing a data merging process through a copying operation on each of the data block and the log block, if the data merging process is completed (step S100), the MCU 130 of FIG. 1 initializes the existing log block and data block (step S110).

As such, according to an embodiment of the present invention, when the data merging process is performed, the control operation can be performed such that the performing of the data merging process is simplified. That is, the new pages are allocated in accordance with the order of commands generated, so as to prevent the sectors from overlapping with respect to the overlapping commands. When the sectors in the pages are allocated in consideration of a copy back command that allows the page buffer of the NAND flash memory to be used, the sectors are allocated in accordance with the predetermined locations of the sectors that are grouped in the pages. Therefore, it is possible to use the copy back command with respect to the continuous sectors.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A solid state storage system, comprising:
a controller configured to divide memory blocks of a flash memory area into first blocks and second blocks corresponding to the first blocks, wherein the controller is configured to newly allocate pages of the second blocks whenever an external write command is requested, allocate selected sectors in the allocated pages according to sector addresses, and execute a write command.

2. The solid state storage system of claim 1,
wherein the controller is configured to allow a vacant area when the selected sectors during the allocation of the sectors are not in place.

3. A solid state storage system, comprising:
a host interface;
a memory area comprising memory blocks, the memory blocks being divided into first blocks and second blocks corresponding to the first blocks; and
a controller configured to allocate pages of the second blocks using an out-of-place method according to the order of commands generated from the host interface, allocate selected sectors in the allocated pages using an in-place method, and execute a write command.

4. The solid state storage system of claim 3,
wherein, when the controller allocates the pages using the out-of-place method, different pages are allocated with respect to overlapping commands.

5. The solid state storage system of claim 3,
wherein, when the controller allocates the selected sectors using the in-place method, the sectors are allocated according to sector addresses of the grouped sectors in the pages of the memory area.

6. A method of controlling a solid state storage system, comprising:
allocating pages using an out-of-place method in a log block in accordance with an external write request and allocating selected sectors according to sector addresses of grouped sectors in the pages using an in-place method;
when a data merging process is performed, merging sectors of first and second blocks using an external buffer unit; and
when the data merging process is performed, merging the sectors of the second blocks using page buffers of a memory area.

7. The method of claim 6,
wherein, in the merging of the sectors using the external buffer unit, effective sectors in the first and second blocks are both read and written in the external buffer unit.

8. The method of claim 6,
wherein, in the merging of the sectors using the page buffers of the memory area, when the grouped sectors in the memory area are matched with continuous sectors of the second blocks a copy back command is executed and buffering is performed in the page buffers.
